(19) United States
(12) Patent Application Publication
(10) Pub. No.: US 2009/0198525 A1
(43) Pub. Date: Aug. 6, 2009

(54) METHOD OF MANAGING A LIFE INSURANCE PLAN AND A SYSTEM THEREFOR

(75) Inventors: Adrian Gore, Houghton Estate (ZA); Herschel Phillip Mayers, Johannesburg (ZA); Kenneth Steven Rabson, Johannesburg (ZA)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(73) Assignee: DISCOVERY HOLDINGS LIMITED, Sandton (ZA)

(21) Appl. No.: 12/303,395

(22) PCT Filed: May 23, 2007
(86) PCT No.: PCT/IB2007/051947

§ 371 Date: Mar. 26, 2009

(30) Foreign Application Priority Data
Jun. 7, 2006 (ZA) 2006/04673

(51) Int. Cl. G06Q 40/00

(52) U.S. Cl. 705/4

(57) ABSTRACT

A method of managing a life insurance plan includes receiving a premium from an insured life. On occurrence of an insured event to the insured life, a predetermined amount is paid out to the insured life and on occurrence of an insured event to a parent of the insured life a predetermined amount is paid out to the insured life.

### BACKGROUND OF THE INVENTION

The present invention relates to a method of managing a life insurance plan and a system therefor.

Conventionally, life insurance plans operate on the basis that an insured person, sometimes referred to as an insured life, pays a premium to the life insurer, and the life insurer pays a predetermined sum, referred to as the sum assured, to the insured life or his/her beneficiary on the occurrence of an insured event. Typical insured events are the insured life suffering disability, contracting a dread disease or dying.

It will be appreciated that the insured events are events which occur to the insured life. However, with limited frail care facilities in certain countries, many people face the burden of looking after sick parents as they age or are no longer able to care for themselves.

This places a financial burden on the insured person for which they have no assistance available through their traditional life cover.

The present invention seeks to address this.

### SUMMARY

According to one example embodiment there is provided, a method of managing a life insurance plan, the method including:
receiving a premium from an insured life;
on occurrence of an insured event to the insured life, paying out a predetermined amount to the insured life; and
on occurrence of an insured event to a parent of the insured life, paying out a predetermined amount to the insured life.

The insured event may be at least one of disability, contracting at least one of a plurality of predetermined diseases or dying.

The insured event for the parent or parents of the insured life may be contracting at least one of a plurality of predetermined diseases.

According to another example embodiment there is further provided an electronic system for managing a life insurance plan includes:
a memory for storing:
   information relating to premiums received from an insured life; and
   information relating to parents of the insured life; and
a processor disposed in communication with the memory, the processor being adapted to:
   receive data indicating the occurrence of an insured event to the insured life, and in response thereto to effect the paying out of a predetermined amount to the insured life; and
   receive data indicating the occurrence of an insured event to a parent of the insured life, and in response thereto to effect the paying out of a predetermined amount to the insured life.

### BRIEF DESCRIPTION OF THE DRAWINGS

FIG. 1 is a flow chart illustrating the methodology of an example embodiment; and

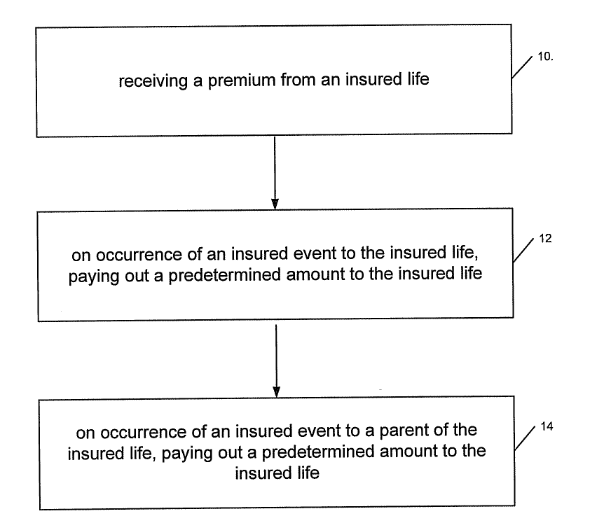

FIG. 2 is a block diagram illustrating an example system to implement the methodologies described herein.

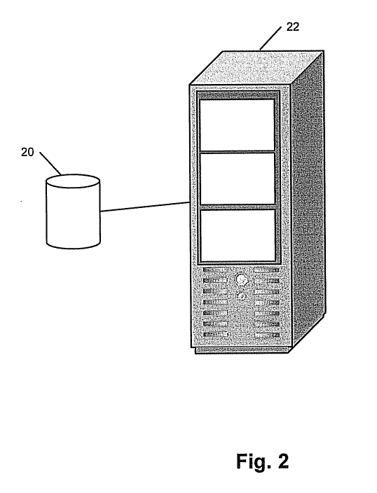

### DESCRIPTION OF EMBODIMENTS

The invention finds application in the field of managing the business and operation of a life insurance plan.

The present invention may be implemented by a traditional life insurance plan operator for its members or may be implemented by another party.

Conventionally, life insurance plans operate on the basis that an insured person, sometimes referred to as an insured life, pays a premium to the life insurer, and the life insurer pays a predetermined sum, referred to as the sum assured, to the insured life or his/her beneficiary on the occurrence of an insured event. Typical insured events are the insured life suffering disability, contracting a dread disease or dying.

Conventional life-insurance plans cover events which occur to the insured life.

However, protection of the insured person's lifestyle is broader than coverage for life changing events happening to the insured life.

The methodology described below protects the lifestyle of the insured life should a parent of the insured life suffer a life changing event, such as a severe illness.

Referring to the accompanying Figures, in an example embodiment, a method includes receiving a premium from an insured life (block 10).

On occurrence of an insured event to the insured life, paying out a predetermined amount to the insured life (block 12).

On occurrence of an insured event to a parent of the insured life, paying out a predetermined amount to the insured life (block 14).

The insured event may be at least one of disability, contracting at least one of a plurality of predetermined diseases or dying.

The insured event for the parent or parents of the insured life may be contracting at least one of a plurality of predetermined diseases.

In one example, a claim is payable should a parent not be able to perform 4 out of 6 Activities of Daily Living defined by the life insurer, which must be measured 3 months after suffering a severe illness.

A typical benefit payable may amount to 5% of the insured life's severe illness benefit per parent, subject to a maximum of R100 000 for both parents. In one example, only one claim per parent will be allowed. The benefit payout will not impact the cover of the insured life.

The life insurer may also offer additional top up cover up, for example, up to R900 000 per parent.

In terms of the automatic inclusion of cover, all pre-existing medical conditions are excluded and a parent will only be covered if there are no disclosures relating to the parent in the family history section of the policyholder's application form.

Parents are underwritten for any additional top up cover required.

The above methodology may be implemented using a system including a memory 20 for storing information relating to premiums received from an insured life and information relating to parents of the insured life.

A processor 22 disposed in communication with the memory is adapted to receive data indicating the occurrence of an insured event to the insured life, and in response thereto to effect the paying out of a predetermined amount to the insured life. The processor is also adapted to receive data indicating the occurrence of an insured event to a parent of the insured life, and in response thereto to effect the paying out of a predetermined amount to the insured life.

The processor may include modules which are implemented by a machine-readable medium embodying instructions which, when executed by a machine, cause the machine to perform any of the methods described above.

It will be appreciated that embodiments of the present invention are not limited to such architecture, and could equally well find application in a distributed, or peer-to-peer, architecture system. Thus the modules illustrated could be located on one or more servers operated by one or more institutions.

1. A method of managing a life insurance plan, the method including:
receiving a premium from an insured life;
on occurrence of an insured event to the insured life, paying out a predetermined amount to the insured life; and
on occurrence of an insured event to a parent of the insured life, paying out a predetermined amount to the insured life.

2. A method according to claim 1 wherein the insured event is at least one of disability; contracting at least one of a plurality of predetermined diseases; and dying.

3. A method according to claim 1 wherein the insured event for the parent or parents of the insured life is contracting at least one of a plurality of predetermined diseases.

4. A method according to claim 3 wherein the insured event is at least one of disability; contracting at least one of a plurality of predetermined diseases; and dying.

5. An electronic system for managing a life insurance plan includes:
a memory for storing:
information relating to premiums received from an insured life; and
information relating to parents of the insured life; and
a processor disposed in communication with the memory, the processor being adapted to:
receive data indicating the occurrence of an insured event to the insured life, and in response thereto to effect the paying out of a predetermined amount to the insured life; and
receive data indicating the occurrence of an insured event to a parent of the insured life, and in response thereto to effect the paying out of a predetermined amount to the insured life.

6. A system according to claim 5 wherein the insured event is at least one of disability; contracting at least one of a plurality of predetermined diseases; and dying.

7. A system according to claim 5 wherein the insured event for the parent or parents of the insured life is contracting at least one of a plurality of predetermined diseases.

8. A system according to claim 7 wherein the insured event is at least one of disability; contracting at least one of a plurality of predetermined diseases; and dying.

9. A system according to claim 6 wherein the insured event for the parent or parents of the insured life is contracting at least one of a plurality of predetermined diseases.

10. A system according to claim 9 wherein the insured event is at least one of disability; contracting at least one of a plurality of predetermined diseases; and dying.

11. A method according to claim 2 wherein the insured event for the parent or parents of the insured life is contracting at least one of a plurality of predetermined diseases.

12. A method according to claim 11 wherein the insured event is at least one of disability; contracting at least one of a plurality of predetermined diseases; and dying.
